(19) United States
(12) Patent Application Publication
(10) Pub. No.: US 2012/0121036 A1
(43) Pub. Date: May 17, 2012

(54) METHOD AND APPARATUS FOR CLOCK SPUR SUPPRESSION IN DIRECT-RF MODULATORS

(75) Inventors: KOEN VAN RENTERGHEM, Merelbeke (BE); JAN ROBERT MAGDALENA CODENIE, Lokeren (BE); WILLY JULES CAESAR GRUWEZ, Heule (BE); MUSTAPHA EL HADDOUCHI, Lille (FR); CHRIS COENE, Torhout (BE)

(73) Assignee: CISCO TECHNOLOGY, INC., San Jose, CA (US)

(21) Appl. No.: 12/947,859

(22) Filed: Nov. 17, 2010

(51) Int. Cl. H04L 25/49

(52) U.S. Cl. 375/296

(57) ABSTRACT

Methods and systems to reduce clock spurs produced by a direct-RF modular to acceptable levels using a digital predistortion compensation signal. The digital compensation signal may be used to generate a sine wave in the digital domain with adjustable phase and amplitude. The digital compensation signal may be added to a digital signal processor (DSP) section of an upconvertor, and may be combined with the undesired clock spur signal to reduce it or even cancel it out completely. In some implementations, the digital predistortion compensation signal may have a similar level of the clock spur such that when added to the clock spur, results in a clock spur having a reduced amplitude.

### BACKGROUND

Digital communication techniques have effectively revolutionized the communications industry by creating efficiencies in bandwidth utilization previously not possible using older analog methods. Information can now generally be conveyed more accurately at higher rates within a smaller bandwidth of a given communications medium. Where spectrum is shared through segmentation of the medium into channels, these efficiencies can permit a higher number of channels through narrower channel widths closer channel spacing than with analog techniques. Digital communication systems generally have superior noise rejection characteristics compared to their analog counterparts, yet care is still taken in their design to avoid cross channel noise that exceeds permissible thresholds.

Digital communication methods generally include the use of an analog carrier signal that is modulated using digital data. The analog carrier permits the digital data to be transmitted in a given frequency range (i.e., a channel) without interfering with signals being transmitted on other frequencies. However, modulating the digital data on the analog carrier can introduce signal imperfections such as clock spurs that may have unacceptable levels. The levels may be such that a radio frequency (RF) modulator may face regulatory issues, reliability problems, and/or customer complaints.

### SUMMARY

Detailed herein are methods and systems to reduce clock spurs produced by a direct-RF modulator to acceptable levels using a digital predistortion compensation signal. The digital compensation signal may be used to generate a sine wave in the digital domain with adjustable phase and amplitude. The digital compensation signal may be added to a digital signal processor (DSP) section of an upconvertor, and may be combined with the undesired clock spur signal to reduce it or even cancel it out completely. In some implementations, the clock spur and digital predistortion may be phasors that are adding together. When the clock spur and digital predistortion phasors are added together, the magnitude of the resulting phasor is lower than the clock spur phasor. The digital predistortion phasor need not be exact opposite phase of the clock spur phasor, but may be an opposite phase if desired.

In accordance with some implementations, there is a method for reducing clock spurs in a direct radio frequency (RF) modulator. The method may include driving a digital-to-analog converter using a reference clock having a frequency; generating a digital predistortion signal to minimize a clock spur that is a sub-harmonic of the frequency of the reference clock; adding the digital predistortion signal to a digital input signal; and converting the digital input signal and the added digital predistortion signal using the digital-to-analog converter. The modulated RF output of the direct radio frequency (RF) modulator will have a clock spur at the sub-harmonic of the frequency of the reference clock having a reduced amplitude as compared to the modulated RF output without the added digital predistortion signal.

In accordance with other implementations, there is provided a radio frequency (RF) modulator for modulating a digital signal. The RF modulator may include an upconverter having an adder, a digital-to-analog converter (DAC) driven by a reference clock having a frequency, a first gain stage, a bandpass filter; and a second gain stage that outputs a modulated RF output signal. The upconverter may receive a digital input signal and a digital predistortion signal that are combined by the adder. The digital predistortion signal may, but is not required to have an opposite phase to a clock spur that is a sub-harmonic of the frequency of the reference clock to reduce the clock spur amplitude in the modules RF output signal.

In accordance with yet other implementations, there is a method comprising receiving a digital input signal at a radio frequency (RF) modulator; adding a digital predistortion signal to the digital input signal, the digital predistortion signal may, but is not required to have an opposite phase to a clock spur that is a sub-harmonic of a frequency of a reference clock that drives a digital-to-analog converter; and converting the digital input signal and the added digital predistortion signal using the digital-to-analog converter. The clock spur at an output of the digital-to-analog converter has a reduced amplitude as compared to the clock spur of the output of the digital-to-analog converter without the added digital predistortion signal.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

The foregoing summary, as well as the following detailed description of illustrative implementations, is better understood when read in conjunction with the appended drawings. For the purpose of illustrating the implementations of the disclosure, there is shown in the drawings example constructions; however, the implementations are not limited to the specific methods and instrumentalities disclosed. In the drawings:

FIG. 1 illustrates an example environment for a radio frequency (RF) modulator with clock spur suppression;

FIG. 2 illustrates an example implementation of an RF modulator including clock spur suppression;

FIG. 3 illustrates example pattern sequences the may be input to the RF modulator as a digital predistortion signal;

FIG. 4 illustrates example output reduction levels of clock spurs for a square wave and for the pattern sequences of FIG. 3;

FIGS. 5A and 5B illustrates example output levels comparing a modulated RF output without and with clock spur suppression, respectively; and

FIG. 6 illustrates example operational flowchart of processes performed to reduce clock spurs in a usable frequency range.

### DETAILED DESCRIPTION

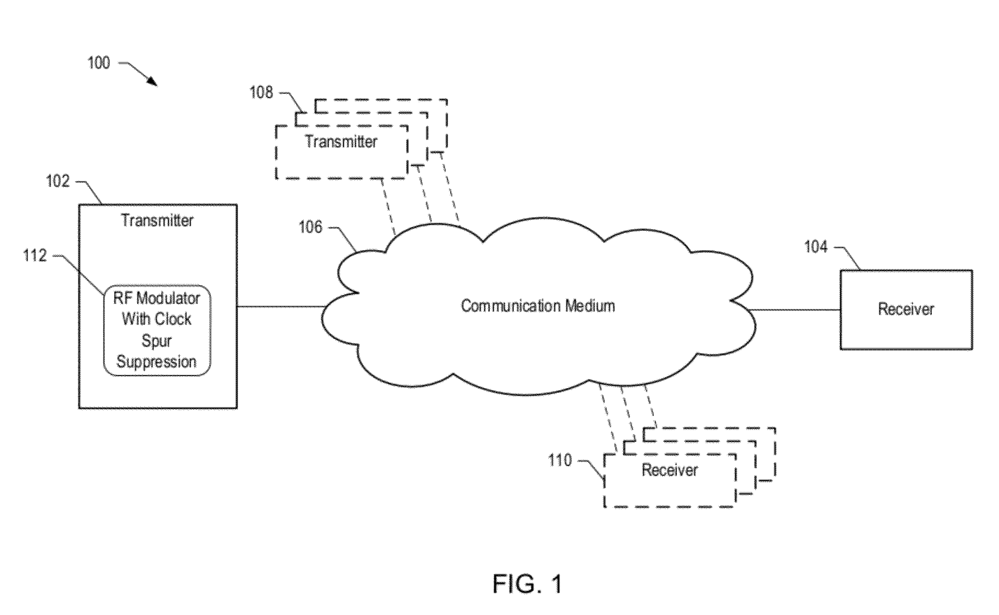

FIG. 1 illustrates an example environment 100 for a radio frequency (RF) modulator with clock spur suppression 112. The transmitter 102 sends digital data to a receiver 104 over a communication medium 106. The communication medium 106 can be any medium through which a transmitted signal can propagate including, but not limited to, the electromagnetic frequency spectrum of the public airwaves, electrically conductive cables, and optical waveguides. The available bandwidth of the communication medium 106 can be divided into two or more channels to enable the propagation of multiple, non-interfering signals using, for example, frequency division multiple access (FDMA). FDMA can permit sharing of the communications medium across a number of devices and/or communication services.

The transmitter 102 and the additional transmitters 108 may adhere to an FDMA scheme by transmitting within respective channels. Channel assignments can be temporary such that they expire after a certain amount of time (e.g., a day, or week, or after completion of a given communication) or more permanent in nature. The transmitter 102 is designed to operate within the frequencies of its assigned channel so as not to interfere with any of the additional transmitters 108 and/or the receipt of signals sent by the transmitters 108 to, for example, the receiver 104 and/or one or more of additional receivers 110.

Components within the transmitter 102, however, may introduce unwanted output signals in frequencies within a usable frequency spectrum. For example, a digital-to-analog converter (DAC) within the transmitter 102 may introduce a clock spur at a sub-harmonic of a DAC reference clock frequency. Thus, to aid in preventing emission of spurious noise, the transmitter 102 includes an RF modulator with clock spur suppression 112, which may add a predistortion signal to the clock spur that may be caused by the DAC in the transmitter 102.

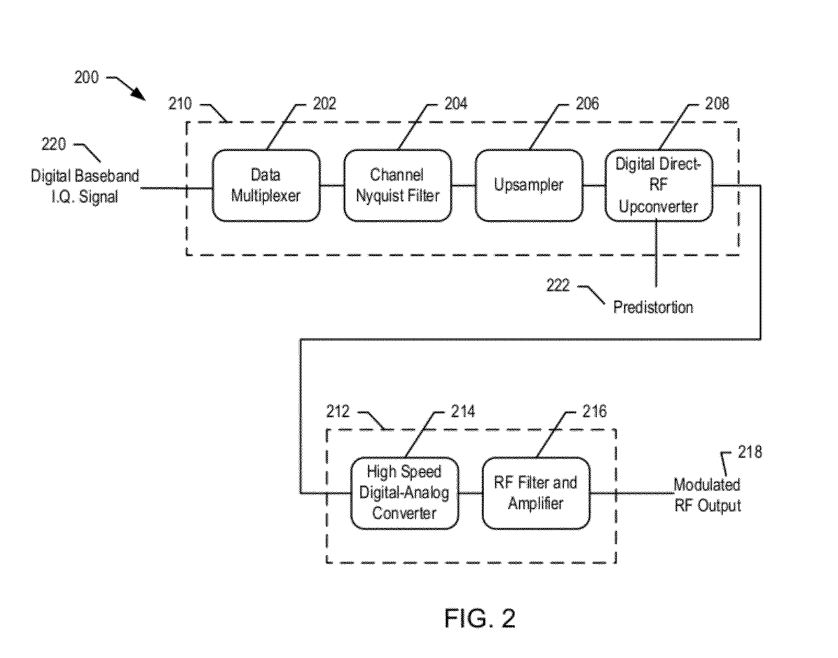

FIG. 2 illustrates an example implementation 200 of an RF modulator including clock spur suppression. The example implementation 200 is a direct-RF quadrature amplitude modulation (QAM) RF modulator. The example QAM modulator can employ, for example, a 16-QAM modulation scheme. A QAM RF modulator is shown as an example. The clock spur suppression techniques described in this disclosure are not limited to any particular digital modulation scheme or hardware.

The example QAM modulator 200 includes a data multiplexer 202 at its input followed by a channel Nyquist filter 204, an upsampler 206, and a digital direct-RF upconverter 208. The dashed line indicates that these elements can, for example, be implemented within a single integrated circuit such as a field programmable gate array (FPGA) or an application specific integrated circuit (ASIC). Such integration options are shown for purposes of example and are not required to practice the described noise control techniques. Any or all of the elements 202, 204, 206, and 208 can be implemented as discrete circuits and/or combinations of hardware, firmware, and/or software without departing from the teachings of this disclosure. RF hardware 212, including a high-speed digital-analog converter 214 and an RF Filter and Amplifier 216, processes the output of the digital direct-RF upconverter 208 to generate the modulated RF output 218 of the QAM modulator 200.

Returning to the input of the QAM modulator 200, the data multiplexer 202 may receive a digital baseband input signal 220 in the form of, for example, line coded in-phase (I) and quadrature (Q) data to be modulated by the example QAM modulator 200. As noted above, a clock spur may be introduced which is a sub-harmonic of the DAC reference clock frequency (F_{dac}).

In accordance with some implementations, to reduce or eliminate a clock spur that occurs within the usable frequency spectrum, a digital predistortion signal 222 that is generated in the digital domain, may be input to the digital direct-RF upconverter 208. For example, the digital predistortion signal 222 may be introduced in the digital direct-RF upconverter 208 using an adder and a memory that contains a sequence defining the digital predistortion signal 222. For example, the digital predistortion signal 222 may be defined as having spectral content at n*F_{dac}/8 (n=1 . . . +inf), where n=1 is the clock spur that the digital predistortion signal 222 seeks to reduce when added to the clock spur. Spectral content is also generated at higher order harmonics (i.e., n>2), however, these are out-of-band and filtered out by the RF filter 216 of FIG. 2.

In some implementations, the clock spur and digital predistortion signal 222 may be defined as phasors that are each adding together. When the clock spur phasor and digital predistortion phasor are added together, the magnitude of the resulting phasor will be lower than the clock spur phasor. To reduce the magnitude of the resulting phasor, the digital predistortion phasor need not be exact opposite phase of the clock spur phasor.

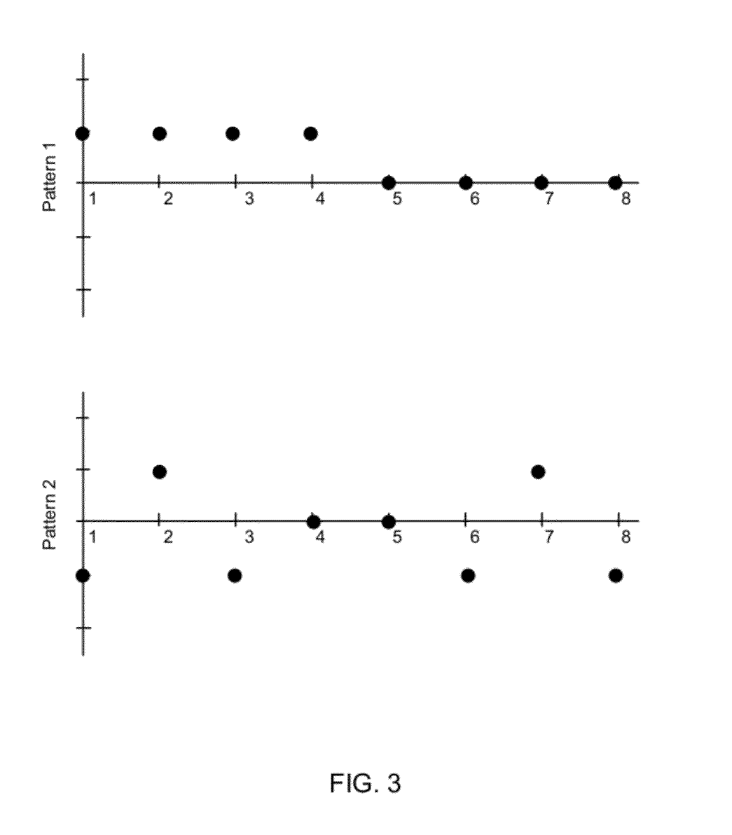

For example, as shown in FIG. 3, if the clock spur occurs at F_{dac}/8, a repeating pattern of eight samples, where four samples are equal to +1LSB followed by four samples equal to −1LSB may be used to generate the desired predistortion frequency together with harmonics. The phase of the generated clock spur can be adjusted in steps of 360/8=45 degrees by shifting the periodic pattern over 1 sample period. The level of the predistortion signal can be controlled by increasing the amplitude of the square wave. Amplitude control can also be achieved by varying the periodic pattern sequence. Any periodic sequence of eight samples long will contain F_{dac}/8 and its harmonics. For DOCSIS QAM modulators (and many other applications), these harmonics are not a problem since they are outside the frequency band of interest. For example, if F_{dac}/8 is higher than 500 MHz, the second harmonic will be above 1 GHz, which is the edge of the DOCSIS 3.0 usable frequency spectrum. Pattern sequences can be devised which have lower energy on the lower order harmonics and more energy in the higher order harmonics, which is outside the usable frequency band. By adding a different sequence to the digital direct-RF upconverter 208, level control can be achieved. Because level control may not be possible in a continuous manner, the level may be controlled in discrete steps of 2 dB.

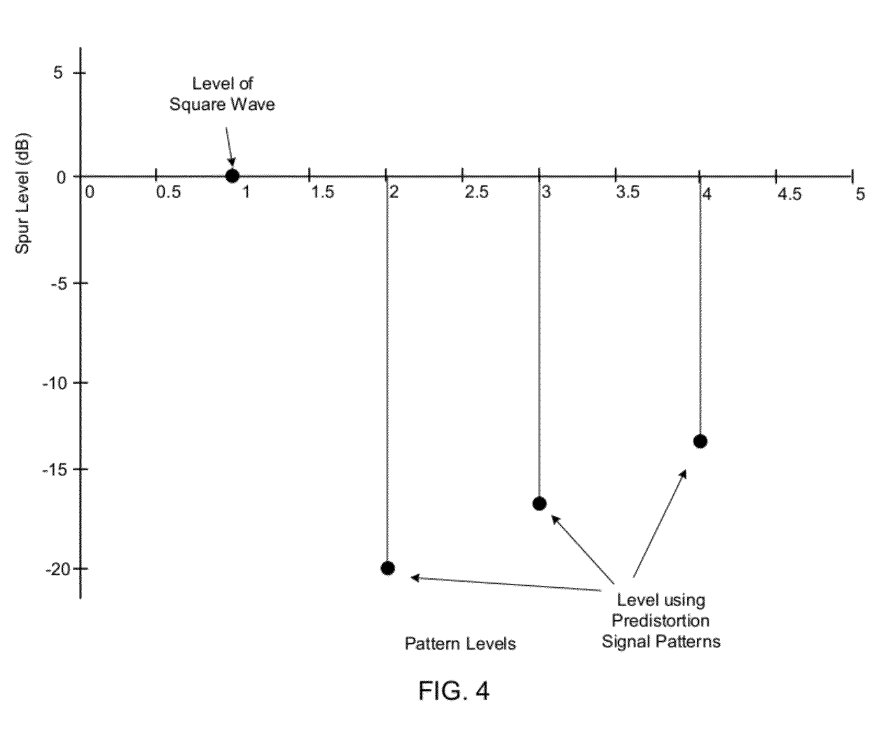

FIG. 4 illustrates a comparison of a square wave to the digital predistortion signal pattern sequences of, e.g., FIG. 3. As shown, lower levels can be reached using the digital predistortion signal pattern sequences than using a square wave of 1 LSB. A spur suppression of 10 dB (or more) is possible, which is adequate to make the output of the QAM modulator 200 compliant with, e.g., the DOCSIS Downstream RF (DRFI) Interface spur specification.

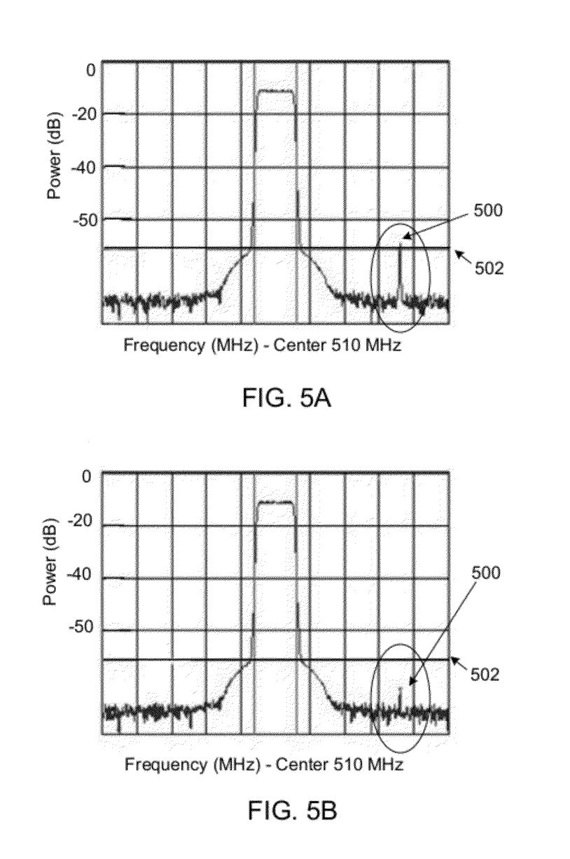

FIGS. 5A and 5B illustrate the results of the QAM modulator 200 without and with the digital predistortion signal, respectively. FIG. 5A shows the base line performance without the digital predistortion signal. A discrete spur 500 results, which is a clock spur of the DAC that occurs at the DAC reference clock divided by 8 (F_{dac}/8). The signal is coupled into the output and violates the DOCSIS DRFI limit 502. In contrast, FIG. 5B demonstrates the effect of the digital predistortion signal. The discrete spur 504 is pushed below the DRFI limit 502.

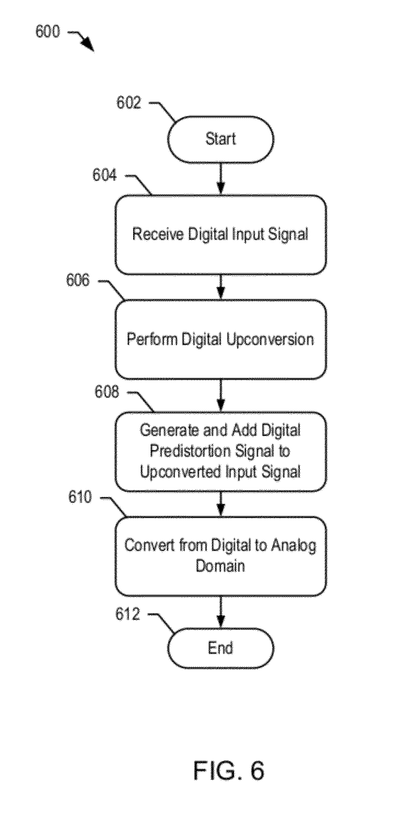

FIG. 6 is a flowchart of an example method 600 of operating an RF modulator with clock spur suppression. The method starts at block 602. At block 604, a digital input signal is received by the QAM modulator. At block 606, digital upconversion is performed on the digital input signal. The digital input signal may be upconverted by the direct-RF upconverter 208.

At 608, the predistortion signal is generated and added to the upconverted input signal. As noted above, a pattern sequence may be defined and loaded into a memory within the digital direct-RF upconverter 208. The pattern sequence may be defined such that when the resulting digital predistortion phasor is added to the clock spur phasor in a sub-harmonic of F_{dac} in the upconverted input signal, the magnitude of a resulting phasor is lower than the clock spur phasor. As noted above, the digital predistortion phasor need not be exact opposite phase of the clock spur phasor so long as the resulting phasor provides for a desired reduction of the clock spur.

At block 610, the digital upconverted signal having the added predistortion signal is converted from digital to analog. For example, the digital to analog conversion may be performed by the DAC 214 to output a modulated RF output having a reduced clock spur as compared to a modulated RF output where the predistortion signal is not added (e.g., at 608).

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

The processes and logic flows described in this specification can be performed by one or more programmable processors executing one or more computer programs to perform functions by operating on input data and generating output. The processes and logic flows can also be performed by, and apparatus can be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed:

1. A method for reducing clock spurs in a direct radio frequency (RF) modulator, comprising:
driving a digital-to-analog converter using a reference clock having a frequency;
upconverting a digital input signal to generate an upconverted input signal;
generating a digital predistortion signal having spectral content at a frequency of a clock spur occurring at a sub-harmonic of the frequency of the reference clock;
adding the digital predistortion signal to the upconverted input signal; and
converting the upconverted input signal and the added digital predistortion signal using the digital-to-analog converter, wherein the clock spur at the sub-harmonic of the frequency of the reference clock at a modulated RF output has a reduced amplitude as compared to the modulated RF output without the added digital predistortion signal.

2. The method of claim 1, further comprising adding the digital predistortion signal in an upconverter of a Quadrature Amplitude Modulation (QAM) RF modulator.

3. The method of claim 1, wherein the sub-harmonic is the frequency divided by eight.

4. The method of claim 1, further comprising adding the digital predistortion signal as a numeric sequence in a digital domain.

5. The method of claim 4, further defining the numeric sequence as a repeating numeric sequence.

6. The method of claim 5, further comprising controlling a phase of the digital predistortion signal by shifting the repeating pattern over one sample period.

7. The method of claim 5, further comprising controlling an amplitude of the digital predistortion signal by varying energy in lower and higher harmonics of the frequency.

8. The method of claim 7, further comprising controlling the amplitude in steps of approximately 2 dB.

9. The method of claim 1, wherein the digital predistortion signal has an opposite phase of the clock spur.

10. A radio frequency (RF) modulator for modulating a digital signal, comprising;
an upconverter having an adder;
a digital-to-analog converter (DAC) driven by a reference clock having a frequency;
a first gain stage;
a bandpass filter; and
a second gain stage that outputs a modulated RF output signal,
wherein the upconverter receives a digital input signal and a digital predistortion signal that are combined by the adder, and wherein the digital predistortion signal has spectral content at a frequency of a clock spur occurring at a sub-harmonic of the frequency of the reference clock to reduce an amplitude of the clock spur in the modulated RF output signal.

11. The system of claim 10, wherein the digital predistortion signal is a repeating numeric sequence in a digital domain.

12. The system of claim 11, wherein a phase of the digital predistortion signal is controlled by shifting the repeating numeric sequence over one sample period.

13. The system of claim 11, wherein an amplitude of the digital predistortion signal is controlled by varying energy in lower and higher harmonics of the frequency.

14. The system of claim 13, wherein the amplitude is controlled in steps of approximately 2 dB.

15. The system of claim 10, wherein the digital predistortion signal has an opposite phase of the clock spur.

16. A method comprising:
receiving a digital input signal at a radio frequency (RF) modulator;
adding a digital predistortion signal to the digital input signal, the digital predistortion signal having spectral content at a frequency of a clock spur occurring at a sub-harmonic of a frequency of a reference clock that drives a digital-to-analog converter; and
converting the digital input signal and the added digital predistortion signal using the digital-to-analog converter,
wherein the clock spur at an output of the digital-to-analog converter has a reduced amplitude as compared to the clock spur of the output of the digital-to-analog converter without the added digital predistortion signal.

17. The method of claim 16, further comprising adding the digital predistortion signal in an upconverter of a Quadrature Amplitude Modulation (QAM) RF modulator.

18. The method of claim 16, further comprising adding the digital predistortion signal as a repeating numeric sequence in a digital domain.

19. The method of claim 18, further comprising:
controlling a phase of the digital predistortion signal by shifting the repeating numeric sequence over one sample period; and
controlling an amplitude of the digital predistortion signal by varying energy in lower and higher harmonics of the frequency.

20. The method of claim 16, wherein the digital predistortion signal has an opposite phase of the clock spur.
